(19) United States
(12) Patent Application Publication
(10) Pub. No.: US 2010/0321596 A1
(43) Pub. Date: Dec. 23, 2010

(54) PROJECTION OPTICAL SYSTEM AND PROJECTION DISPLAY UNIT USING THE SAME

(76) Inventor: Naofumi Ishikura, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/735,772

(22) PCT Filed: Mar. 6, 2008
(86) PCT No.: PCT/JP2008/054035

§ 371 Date: Aug. 17, 2010

(51) Int. Cl. G02F 1/13357; G03B 21/14

(52) U.S. Cl. 349/5; 353/38; 353/31

(57) ABSTRACT

A projection optical system which improves the illumination efficiency includes a light source, an optical waveguide into which light from the light source enters and from which the light exits as reflected light, a diffuser diffusing light that has exited from the optical waveguide, a prism sheet into which light diffused by the diffuser enters and in which prisms are arranged on one plane, and a rod integrator into which light transmitted through the prism sheet enters.

### TECHNICAL FIELD

The present invention relates to a projection optical system capable of improving the light use efficiency of a projection display unit (hereinafter referred to as the projector) that uses a laser as a light source.

### BACKGROUND ART

Projectors use a light beam that has a certain degree of divergence. The light beam is caused to directly enter a rod integrator and to be reflected inside the rod integrator, thereby making the light entering a light bulb uniform.

Under these present circumstances, small projectors with a laser light source are being developed. The reasons include: (1) the laser light source has a wide range of color reproduction and high monochromaticity; (2) high-resolution and high-intensity images can be obtained because of the high concentration of light due to a small light emission point; (3) laser light is polarized and therefore has good compatibility with a liquid-crystal panel; and (4) the laser light source does not generate unwanted light such as infrared and ultraviolet light and has longer life than an extra high pressure mercury lamp.

However, the laser light source is highly directional and emits a light beam that has extremely low divergence. Therefore, if the laser beam is caused to directly enter the rod integrator of the projector, the directionality prevents the light beam from being reflected inside the rod integrator (that is, the amount of light beam reflected is small) and therefore the distribution of light beams that have passed through the rod integrator are not made uniform.

To address the problem, a method for a laser-based projector has been proposed in which a convex lens is disposed in front of a rod integrator to spread or narrow a light beam before the light beam enters the rod integrator, thereby causing the light beam to be reflected inside the rod integrator (Patent Document 1: JP2002-49096A).

However, the method that uses the convex lens requires space to dispose the convex lens in the section between the light source and the rod integrator, thus increasing the size of the optical system.

On the other hand, a structure may be contemplated in which a diffuser is disposed in front of the incidence end of the rod integrator to spread a light beam. There is a well-known diffuser technique that can diffuse a light beam in a particular direction (Patent Document 2: JP2003-330110A).

Only a small space for the thickness of the diffuser is needed to dispose such a diffuser in front of the incidence end of the rod integrator.

However, not all light beams enter the rod integrator in the structure; some of the light beams are reflected by the diffuser and others are diffused wider than the opening at the incidence end of the rod integrator by the diffuser and go out. Accordingly, the amount of light that enters the rod integrator decreases to reduce the light use efficiency.

### [Patent Document 1] JP2002-49096A

### [Patent Document 2] JP2003-330110A

### DISCLOSURE OF THE INVENTION

An object of the present invention is to provide a projection optical system for a projector that is capable of solving the problems with the background art described above. An example of the object of the present invention is to significantly improve the amount of light entering a rod integrator.

An aspect of a projection optical system of the present invention includes a light source, an optical waveguide into which light from the light source enters and from which the light exits as reflected light, a diffuser diffusing light that has exited from the optical waveguide, a prism sheet into which light diffused by the diffuser enters, and a rod integrator into which light transmitted through the prism sheet enters. The prism sheet has prisms arranged on one of its surface.

### BRIEF DESCRIPTION OF THE DRAWINGS

FIG. 1 is a diagram illustrating an exemplary embodiment of a projection optical system according to the present invention;

FIG. 2 is a diagram illustrating a detailed configuration of a prism sheet used in the present invention;

FIG. 3 is a diagram illustrating a light-beam optical path provided by the prism sheet in FIG. 2;

FIG. 4 is a diagram illustrating a DLP projector in which the projection optical system of the present invention is used;

FIG. 5 is a diagram illustrating another exemplary embodiment of a projection optical system of the present invention;

FIG. 6 is a diagram illustrating an LCD projector in which the projection optical system in FIG. 5 is used;

FIG. 7 is a diagram illustrating another exemplary configuration of a prism sheet section used in the present invention; and

FIG. 8 is a diagram illustrating another exemplary configuration of an optical waveguide section used in the present invention.

### DESCRIPTION OF SYMBOLS

100: Enlarged view of a portion of a prism sheet
110, 110(R), 110(G), 110(B): Laser light source
120: Optical waveguide
130: Diffuser
140: Prism sheet
150: Rod integrator
160, 170, 190: Condenser lens
180: Reflecting mirror
200: DMD
210, 440: Projection lens
220, 230: Dichroic mirror
300, 300(R), 300(G), 300(B): Projection optical system
410: Field lens
420: Liquid-crystal panel
430: Cross dichroic prism
500: Incident light flux
510, 520, 530, 540: Outgoing light flux
610, 620, 630: Light beam incident on prism
700, 710: Reflecting mirror
720: Wavelength plate
730: Reflective polarizer
800, 810: Prism sheet
820: Diffuser
830: Incident light from optical waveguide
840: Outgoing light to rod integrator

### BEST MODE FOR CARRYING OUT THE INVENTION

Best mode for carrying out the present invention will be described below with reference to drawings.

### First Exemplary Embodiment

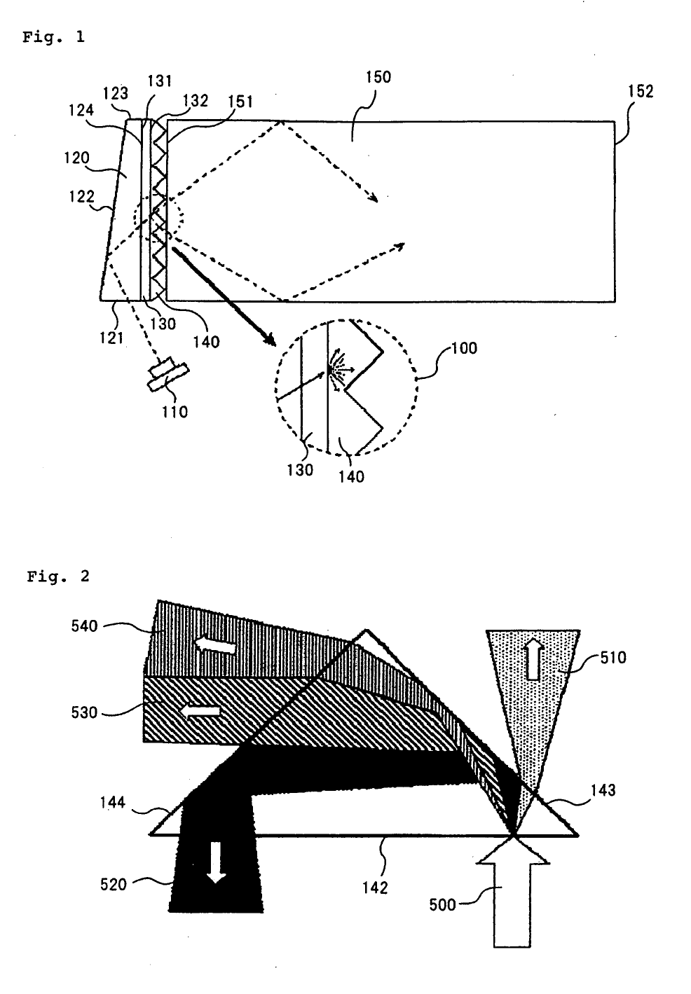

FIG. 1 is a diagram illustrating a configuration of a projection optical system according to a first exemplary embodiment of the present invention. FIG. 2 is a diagram illustrating details of a prism section of a prism sheet illustrated in FIG. 1.

Referring to FIG. 1, a projection optical system of the present exemplary embodiment includes light source 110, optical waveguide 120, diffuser 130, prism sheet 140 and rod integrator 150.

Light source 110 is a laser light source, which is highly directional. Optical waveguide 120 is made of a material that has a high transmittance, thickness accuracy, and surface accuracy (for example polymethylmethacrylate (PMMA)).

Surfaces 122 and 123 of optical waveguide 120 are coated with a reflective coat having a reflectance of nearly 100%. A reflecting mirror may be disposed on surfaces 122 and 123, instead of the reflective coat.

Optical waveguide 120 has incidence surface 121 on which light from light source 110 is incident and exit surface 124 through which the light exits. An AR coating (Anti Reflection Coating) is applied to each of incidence surface 121 and exit surface 124 so that nearly 100% of light passes through surfaces 121 and 124.

Diffuser 130 is opposed to exit surface 124 of optical waveguide 120 in order to diffuse a light beam that travels toward rod integrator 150. Diffuser 130 is made of semi-transparent white ground glass or resin material.

Prism sheet 140 is made of acrylic resin. Prism sheet 140 has a structure in which many prisms, each having the shape of a triangular pole, are arranged in parallel in one direction on a two-dimensional plane. Many sets of roofs are arranged on one surface in parallel, each set including two sloped faces forming a predetermined angle with each other, to form what is called a prism sheet.

One flat surface of prism sheet 140 is opposed to exit surface 132 of diffuser 130.

While prism sheet 140 in FIG. 1 is depicted as having only eight prisms, prism sheet 140 actually has more than several times as many prisms.

Rod integrator 150 is a rod lens of a transmissive material cut into a square pole, or a light tunnel formed by a combination of four flat mirrors provided inside a rectangular tube.

A light path in the projection optical system of the exemplary embodiment will be described below.

Laser light emitted from light source 110 enters optical waveguide 120 through incidence surface 121, is reflected by surface 122, passes through exit surface 124 and is incident on the incidence surface 131 of diffuser 130. The position of light source 110 is adjusted so that the light beam reaches roughly the center of exit surface 124 of optical waveguide 120.

The light beam exiting through exit surface 124 and incident on incidence surface 131 of diffuser 130 diffuses at the surface of or inside diffuser 130, becomes a light flux spreading in certain directions, and exits through surface 132. Light flux exiting diffuser 130 enters prism sheet 140. The enlarged view in the inset of FIG. 1 illustrates the light flux that has entered portion 100 of prism sheet 140.

Among the light fluxes that have entered prism sheet 140, light fluxes that are at a certain angle with respect to a roof-like surface at the exit end of prism sheet 140 are transmitted whereas light fluxes at another certain angle are reflected.

The light fluxes transmitted through prism sheet 140 enter rod integrator 150 through opening surface 151 at the incidence end of rod integrator 150, are then repeatedly reflected inside rod integrator 150, and eventually exit through exit surface 152.

FIG. 2 illustrates details of the structure (one of the triangular prisms) of prism sheet 140.

Part 500 of light beams that have been diffused at diffuser 130 at a certain angle (the angle of divergence) is incident on incidence surface 142 of the prism as illustrated in FIG. 2. While light beams are incident on the entire incidence surface 142, only part of the light beams is depicted in FIG. 2.

A light flux that has entered the prism through incidence surface 142 is incident on slope face 143. Here, the light flux incident on slope face 143 is considered separate light fluxes 510, 520, 530 and 540.

Light flux 510 passes through slope face 143 and directly enters the rod integrator (not depicted). Since the incidence angle of the light beam of light flux 510 to slope face 143 does not exceed a critical angle which is determined by the refractive index of the prism, light flux 510 passes through slope face 143.

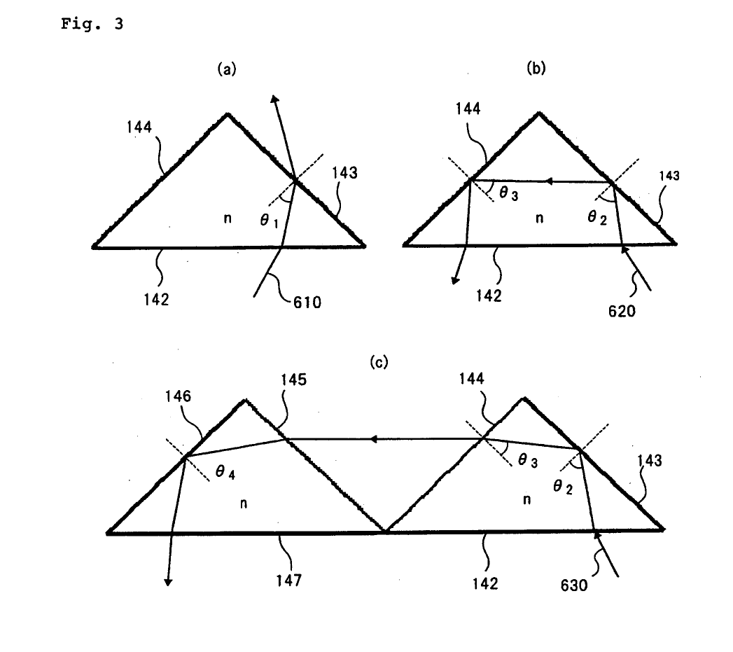

The light path of the light beam is illustrated in FIG. 3(a). Light beam 610 incident on incidence surface 142 of the prism passes through slope face 143. Letting n denote the refractive index of prism 141 and θ₁ denote the incidence angle of light beam 610 incident on surface 143 of the prism, then Expression (1) given below holds.

[Expression 1]

θ₁<sin⁻¹·(1/n) (1)

The light beam of light flux 520 illustrated in FIG. 2 is incident on slope face 143 at an angle greater than the critical angle and therefore is totally reflected by the slope face 143 and is incident on the other slope face 144.

The light path of the light beam is depicted in FIG. 3(b). Light beam 620 incident on incidence surface 142 of the prism having refractive index n is incident on slope face 143. Light beam 620 incident on slope face 143 at an incidence angle θ₂ is totally reflected by slope face 143 to the other slope face 144 since the incidence angle θ₂ exceeds the critical angle.

Light beam 620 incident on slope face 144 is at an incidence angle θ₃. Since the incidence angle θ₃ exceeds the critical angle, light beam 620 is totally reflected by slope face 144, then passes through incidence surface 142 and exits the prism in the direction opposite the direction in which light beam 620 has entered the prism. Here, Expression (2) given below holds.

[Expression 2]

θ₂>sin⁻¹(1/n)

θ₃>sin(1/n) (2)

Then, light beam 620 thus returned from the prism is diffused again by diffuser 130 depicted in FIG. 1 and enters optical waveguide 120. The light beam is reflected by surface 122 and reenters diffuser 130 and then enters prism sheet 140. The light entering prism sheet 140 is split by the slope faces of the prisms into light fluxes that pass through the prisms and light fluxes that are totally reflected by the slope faces of the prisms as described above.

Light beam 620 repeatedly travels through the light path between optical waveguide 120 and prism sheet 140 before light beam 620 exits the prism toward rod integrator 150.

Light flux 530 illustrated in FIG. 2 also is incident on slope face 143 of the prism at an angle greater than the critical angle and therefore is totally reflected by slope face 143 and then is incident on the other slope face 144. Unlike light flux 520, light flux 530 is incident on slope face 144 at a smaller angle than the critical angle and therefore passes through slope face 144 and enters an adjacent prism.

The light path of the light beam is illustrated in FIG. 3(c). Light beam 630 is incident on surface 142 and then incident on slope face 143 at angle θ₂. Since the incidence angle θ₂ exceeds the critical angle, light beam 630 is totally reflected by slope face 143. Then, light beam 630 is incident on the other slope face 144 at angle θ₃. Since the incidence angle θ₃ is smaller than the critical angle, light beam 630 passes through slope face 144.

The light beam that has passed through slope face 144 is incident on slope face 145 of an adjacent prism and is then incident on the other slope face 146 of the prism at an angle θ₄. Since the angle of incidence on slope face 146 exceeds the critical angle, the light beam is totally reflected by slope face 146 and passes through incidence surface 147 of the prism. Here, Expression (3) given below holds.

[Expression 3]

θ₂>sin⁻¹(1/n)

θ₃<sin⁻¹(1/n)

θ₄>sin⁻¹(1/n) (3)

Then, light beam 630 returned from the adjacent prism is diffused again by diffuser 130 depicted in FIG. 1 and enters optical waveguide 120. The light beam is reflected by surface 122, reenters diffuser 130 and then enters prism sheet 140. The light that has entered prism sheet 140 is split by the slope faces of the prisms into light fluxes that pass through the prisms and light fluxes that are totally reflected by the slope faces of the prisms as described above.

In this way, light beam 630 repeatedly travels through the light path between optical waveguide 120 and prism sheet 140 before light beam 630 exits the prism toward rod integrator 150.

Light flux 540 depicted in FIG. 2 travels through the same light path as light beam 630 depicted in FIG. 3. However, light flux 540 does not enter the adjacent prism after passing through slope face 144 but is directly transmitted in a lateral direction. The light beam is wasted but the amount of the wasted light is so small that it has an insignificant influence on reducing in the total amount of light.

In the projection optical system described above, prism sheet 140 is disposed between the diffuser and the rod integrator. With this arrangement, some of light beams that do not enter the rod integrator can be returned by the diffuser to the rod integrator. That is, incident light is recycled. As a result, more light beams can be caused to enter the rod integrator. The quantity of light fluxes that can be caused to enter the rod integrator is more than double the light fluxes that can be caused to enter the rod integrator by using only a diffuser to spread laser light without disposing the prism sheet of the present invention.

Accordingly, the amount of light can be significantly increased compared with an optical system in which only a diffuser is used to spread the angle of light beams to cause light beams to enter the rod integrator. That is, illumination efficiency can be significantly increased.

Furthermore, the projection optical system in FIG. 1 enables only light beams to be emitted that have a high intensity distribution toward the front of the opening end of the rod integrator and have a certain angular component like light flux 510 in FIG. 2.

### Second Exemplary Embodiment

A configuration of a DLP (registered trademark) based projector (hereinafter referred to as DLP projector) in which the projection optical system in FIG. 1 is used will be described. A DLP projector is a time-division projection display unit that uses a digital micromirror device (hereinafter referred to as DMD) having several hundred thousand mirror elements mounted on semiconductor memory cells. The tilt of each of the mirror elements can be controlled.

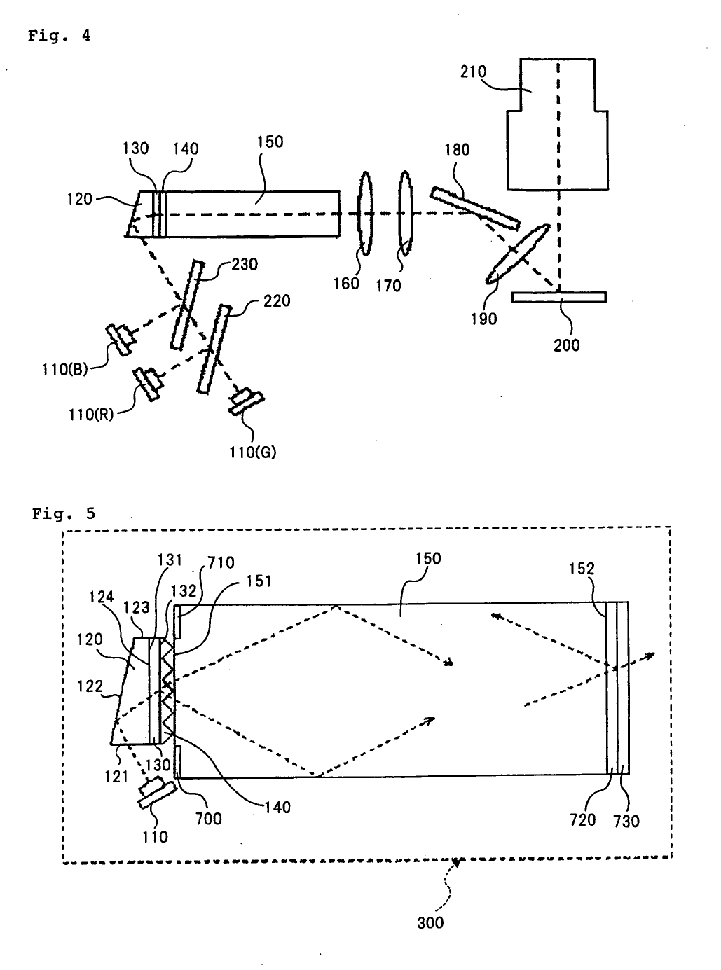

FIG. 4 is a diagram illustrating a DLP projector of the present exemplary embodiment in which the projection optical system described above is used.

Referring to FIG. 4, the DLP projector of the present exemplary embodiment includes the projection optical system illustrated in FIG. 1, digital micromirror device (DMD) 200 which is a light bulb, a set of condenser lenses 160, 170 and 190 for conjugating a light exit surface of rod integrator 150 of the projection optical system and the light bulb, and projection lens 210 for forming and projecting an enlarged image of light that has passed through the light bulb.

A light path in the DLP projector of the present exemplary embodiment will be described below.

A light beam in a green wavelength band is emitted from laser light source 110(G), passes through dichroic mirrors 220 and 230, which are color separating optical systems, in this order, and enters optical waveguide 120. Dichroic mirror 220 has a film characteristic that passes light beams in the green wavelength band and reflects light beams in a red wavelength band. On the other hand, dichroic mirror 230 has a film characteristic that passes light beams in green and red wavelength bands and reflects light beams in the blue wavelength band.

A light beam in the red wavelength band is emitted from laser light source 110(R), is reflected by dichroic mirror 220, passes through dichroic mirror 230, and enters optical waveguide 120.

A light beam in the blue wavelength band is emitted from laser light source 110(B), is reflected by dichroic mirror 230 and enters optical waveguide 120.

The color light beams (R, G, and B) that have entered optical waveguide 120 are reflected inside optical waveguide 120 and then enter diffuser 130.

The light beams that have entered diffuser 130 are diffused and enter prism sheet 140. Some of light beams that have entered prism sheet 140 are transmitted forward (toward rod integrator 150) and other light beams pass through diffuser 130 and return to optical waveguide 120. The light beams are reflected by optical waveguide 120 and reenter prism sheet 140. In this way, some of the light beams travel back and forth between optical waveguide 120 and prism sheet 140 and eventually exit toward rod integrator 150.

In this way, some of the light beams that are diffused by diffuser 130 do not enter rod integrator 150 can be recycled as light entering rod integrator 150. Accordingly, the amount of light entering rod integrator 150 can be increased.

Light beams passing through prism sheet 140 and entering rod integrator 150 are repeatedly reflected inside rod integrator 150 before exiting rod integrator 150. Consequently, the light intensity distribution of light exiting the rod integrator is made uniform.

The light beams that have exited rod integrator 150 pass through condenser lenses 160 and 170, are reflected by mirror 180, pass through condenser lens 190, and then enter DMD 200. The light beams are modulated in DMD 200 and are projected onto a screen (not depicted) through projection lens 210.

### Third Exemplary Embodiment

When the projection optical system of the present invention is used in a DLP projector as illustrated in FIG. 4, a structure for polarizing light beams in a particular direction (for example PBS: Polarized Beam Splitter) does not need to be provided. However, when the projection optical system is used in an LCD projector, light needs to be polarized in a particular direction depending on a transmission characteristic of the liquid-crystal panel before the light enters the liquid-crystal panel. Therefore, the direction of polarization needs to be determined in the projection optical system. Such a configuration will be described by way of example.

FIG. 5 is a diagram illustrating an exemplary embodiment of the projection optical system of the present invention used in an LCD projector.

Referring to FIG. 5, the projection optical system includes, in addition to the components of the projection optical system illustrated in FIG. 1, reflecting mirrors 700 and 710 formed on surface 151 on the light incidence end of rod integrator 150, wavelength plate 720 disposed on surface 152 at the light exit end of rod integrator 150, and reflective polarizer 730 disposed on wavelength plate 720. There is an opening between reflecting mirrors 700 and 710 to allow light to enter.

A light path in projection optical system 300 configured as described above will be described. Laser light emitted from light source 110 enters optical waveguide 120 through incidence surface 121, is reflected by surface 122, passes through exit surface 124, and is incident on incidence surface 131 of diffuser 130. Here, the position of light source 110 is adjusted so that the light beam reaches roughly the center of exit surface 124 of optical waveguide 120.

The light beam exiting through exit surface 124 and incident on incidence surface 131 of diffuser 130 diffuses at the surface of or inside diffuser 130, becomes a light flux spreading in certain directions, and exits through surface 132. The light flux exiting diffuser 130 enters prism sheet 140.

Among the light fluxes that have entered prism sheet 140, light fluxes that are at a certain angle with respect to a roof-like surface at the exit end of prism sheet 140 are transmitted whereas light fluxes at another certain angle are reflected.

The light fluxes transmitted through prism sheet 40 enter rod integrator 150 through surface 151. The light enters rod integrator 150 through the opening between mirrors 700 and 710 provided at surface 151.

The light beams that have entered rod integrator 150 are repeatedly reflected inside rod integrator 150 and exit through surface 152.

The light beams that have exited rod integrator 150 pass through wavelength plate 720 and are incident on reflective polarizer 730. Here, light beams having a certain polarization component pass through reflective polarizer 730 whereas light beams having a polarization component orthogonal to the polarization component are reflected. The reflected light beams return to the light incidence end of rod integrator 150, are reflected by mirrors 700 and 710 on surface 151 of the light incidence end, and are repeatedly reflected again inside rod integrator 150, and are then incident on wavelength plate 720 and reflective polarizer 730.

While the light beams are traveling back and forth between reflective polarizer 730 and mirrors 700 and 710 in this way, the light beams pass through wavelength plate 720 twice to change their polarization direction and become able to pass through reflective polarizer 730 when the light beams have reached reflective polarizer 730.

Thus, light beams travel back and forth between reflective polarizer 730 and mirrors 700 and 710 and only light beams having a polarization component polarized in a certain direction eventually exit rod integrator 150.

In the course of light described above, there are also light beams that are reflected by reflective polarizer 730 and pass through the opening between mirrors 700 and 710. The light beams pass through prism sheet 140 and diffuser 130, are reflected by optical waveguide 120 and reenter rod integrator 150. Accordingly, there is little loss of light beams that escape from rod integrator 150 to the outside of prism sheet 140. Therefore, most of incident light is polarized in the same direction and can exit rod integrator 150.

### Fourth Exemplary Embodiment

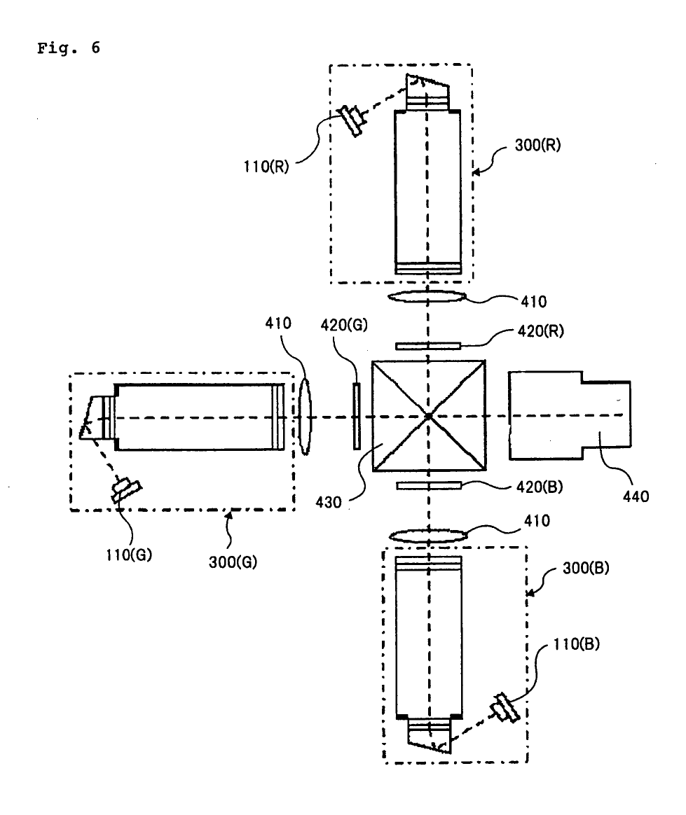

An exemplary configuration of an LCD projector that uses the projection optical system 300 described above will be described below with reference to FIG. 6.

The LCD projector of the present exemplary embodiment includes projection optical systems 300(G), 300(R) and 300(B) having the configuration illustrated in FIG. 5, liquid-crystal display devices (LCD) 420(G), 420(R) and 420(B) which are light bulbs, cross dichroic prism 430 which is a color combining optical system that combines light that has passed through the light bulbs, and projection lens 440 for forming and projecting an enlarged image of light that has passed through cross dichroic prism 430.

A light path in the LCD projectors of the present exemplary embodiment will be described below.

A light beam in a green wavelength band is emitted from laser light source 110(G), passes through projection optical system 300(G) and field lens 410, and enters liquid-crystal panel 420(G). The light beam modulated by and transmitted through liquid-crystal panel 420(G) enters cross dichroic prism 430.

As with the green light beam, a light beam in a red wavelength band is emitted from laser light source 110(R), Passes through projection optical system 300(R) and field lens 410, and then enters liquid-crystal panel 420(R). The light beam modulated by and transmitted through liquid-crystal panel 420(R) enters cross dichroic prism 430.

As with the green light beam, a light beam in a blue wavelength band is emitted from laser light source 110(B), passes through projection optical system 300(B) and field lens 410, and enters liquid-crystal panel 420(B). The light beam modulated by and transmitted through liquid-crystal panel 420(B) enters cross dichroic prism 430.

The color light beams (R, G and B) that have entered cross dichroic prism 430 are combined in cross dichroic prism 430 and the combined light beam exits toward projection lens 440. The emitted light beam is projected on a screen (not depicted) through projection lens 440.

Since the present exemplary embodiment uses projection optical systems 300 capable of returning some light beams that do not enter rod integrator 150 to rod integrator 150, the amount of light reaching the screen significantly increases compared with conventional LCD projectors.

### Fifth Exemplary Embodiment

Another mode of a prism sheet constituting the projection optical system in FIG. 1 or 5 will be described below.

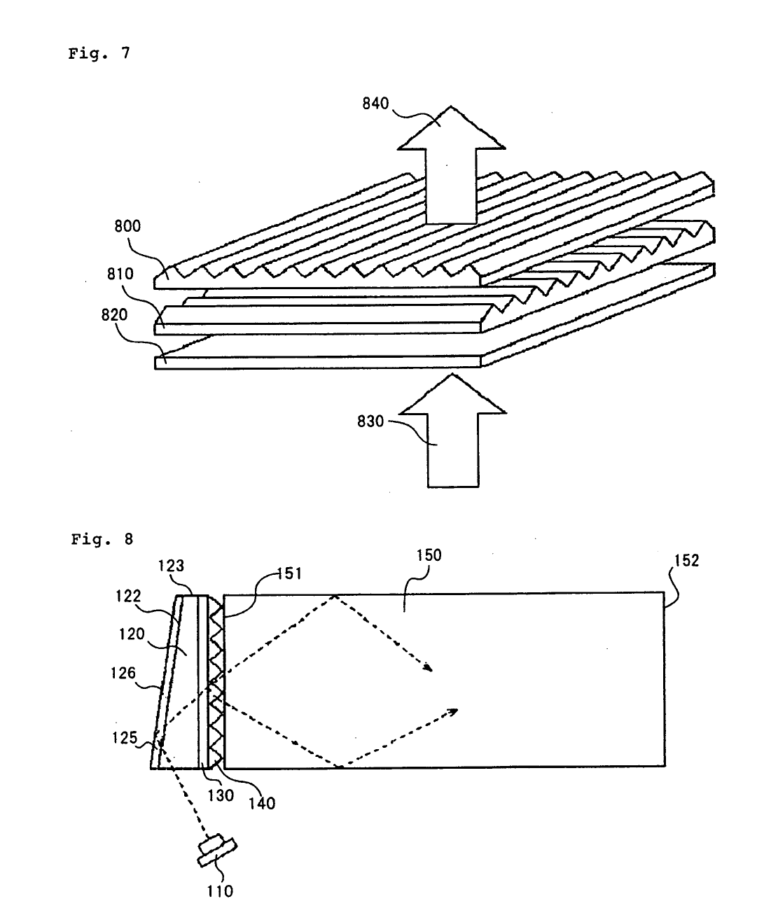

FIG. 7 is a perspective view illustrating another exemplary configuration of the prism sheet used in the present invention. In the present exemplary embodiment, another prism sheet 810 is stacked on prism sheet 800 in such a manner that arrangements of prisms are orthogonal to each other. Each of prism sheets 800 and 810 has the same configuration as prism sheet 140 described with respect to the first exemplary embodiment.

With the configuration described above, light beam 830 that has passed through optical waveguide (not depicted) and entered diffuser 820 is transmitted through prism sheets 800 and 810 as illustrated in FIG. 7, and then the transmitted light 840 enters a rod integrator (not depicted).

In the transmission, the incident light beam spreads around the prism sheets not only in one direction parallel to one plane of the prism sheets on which prisms are arranged but also in the direction orthogonal to this direction. This has the effect of reducing differences in luminance and unevenness in luminance in the opening surface at the light incidence end of rod integrator 150.

While the two prism sheets decrease the transmittance (the amount of transmitted light) as compared with one prism sheet, light beams equivalent to the decreased amount of light return to the optical waveguide and reenter the prism sheets.

Accordingly, light beams that have not passed through the prism sheets travel back and forth between the light guide and the set of prism sheets and eventually enter the rod integrator. Therefore the reduction in the transmittance is insignificant. That is, reduction in luminance at the opening surface on the light incidence end of the rod integrator is negligible.

### Sixth Exemplary Embodiment

Another form of the diffuser section constituting the projection optical system in FIG. 1 or 5 will be described below.

FIG. 8 is a diagram illustrating a configuration of a projection optical system according to another exemplary embodiment of the present invention.

The projection optical system of the present exemplary embodiment has a configuration in which additional diffuser 125 is disposed on surface 122 of optical waveguide 120 illustrated in FIG. 1. Surface 122 in the configurations illustrated in FIGS. 1 and 5 is a reflecting surface having a reflective coat whereas surface 122 in the present exemplary embodiment is transmissive but instead of having a transmissive surface the surface of diffuser 125 that is not in contact with surface 122 is a reflecting surface.

If a light beam from the light source used in a projector has a certain degree of divergence, there is no need to spread the light beam to be incident on the diffuser. However, in the case of a projector that uses a laser light source, which is highly directional, the amount of light passed through a diffuser tends to be greater in a central area of the light incidence surface of the prism sheet and smaller in the area surrounding the central area even though the light beams have been passed through the diffuser.

To address the problem, a light beam is forced to enter another diffuser 125 as illustrated in FIG. 8 to diffuse and spread the light beam before the light beam enters diffuser 130 and prism sheet 140. This can reduce unevenness in luminance at the light incidence surface of prism sheet 140.

### Seventh Exemplary Embodiment

The prism sheets in the exemplary embodiments described above have a structure in which many triangular prisms are arranged on one plane. However, the effect of the present invention can be achieved by other structures as well in which light beams that have not entered the rod integrator can be returned to the rod integrator by using a diffuser. Therefore, the shape, size, array pitch and other parameters of the prisms in the prism sheets of the present invention are not limited to those disclosed in the drawings.

### Eighth Exemplary Embodiment

While examples in which a laser light source is used as the light source have been described above, the present invention has the same effect as described above even if the laser light source is replaced with an LED or a discharge lamp such as an extra high pressure mercury lamp. However, since an LED and a discharge lamp emit light having low directionality, the shape and other parameters of the optical waveguide need to be modified from those of the optical waveguide in the optical system that uses a laser light source.

While the present invention has been described with respect to exemplary embodiments thereof, the present invention is not limited to the exemplary embodiments described above. Various modifications which may occur to those skilled in the art can be made to forms and details of the present invention without departing from the technical idea of the present invention.

1. A projection optical system comprising:
a light source;
an optical waveguide into which light from the light source enters and from which the light exits as reflected light;
a diffuser diffusing light that has exited from the optical waveguide;
a prism sheet into which light diffused by the diffuser enters and in which prisms are arranged on one plane; and
a rod integrator into which light transmitted through the prism sheet enters.

2. The projection optical system according to claim 1, wherein the prism sheet is one in which prisms each having the shape of a triangular pole are adjacent to each other and a large number of the prisms are arranged in one direction on a two-dimensional plane.

3. The projection optical system according to claim 1, wherein any of the surfaces of the optical waveguide comprises a reflecting surface coated with a reflective coat.

4. The projection optical system according to claim 1, wherein any of the surfaces of the optical waveguide comprises a light transmissive surface.

5. The projection optical system according to claim 1, wherein the diffuser is disposed in contact with at least two surfaces of the optical waveguide.

6. The projection optical system according to claim 1, wherein two of the prism sheets are stacked on top of one another.

7. The projection optical system according to claim 1, wherein two of the prism sheets are stacked on top of one another and a lens arrangement direction of one of the prism sheets is orthogonal to a lens arrangement direction of the other of the prism sheets.

8. The projection optical system according to claim 1, wherein the rod integrator comprises a rod lens formed by cutting a transmissive material into a square pole or a light tunnel formed by a combination of four flat mirrors provided inside a rectangular tube.

9. The projection optical system according to claim 1, wherein a reflecting surface perpendicular to an optical axis direction in which light travels is provided on a light incidence surface of the rod integrator and an opening through which light enters is provided in a portion of the light incidence surface excluding the reflecting surface; and
a wavelength plate and a reflective polarizer are provided on a light exit surface of the rod integrator in this order from the light exit surface.

10. The projection optical system according to claim 1, wherein the light source comprises a laser light source.

11. The projection optical system according to claim 1, wherein the light source comprises an LED.

12. The projection optical system according to claim 1, wherein the light source comprises a discharge lamp.

13. The projection optical system according to claim 1, further comprising as the light source a red light source emitting light having a red wavelength, a green light source emitting light having a green wavelength, and a blue light source emitting light having a blue wavelength; and
a dichroic mirror combining light from the red light source, light from the green light source and light from the blue light source together on the same axis and causing the combined light to enter the optical waveguide.

14. A projection display unit comprising:
a projection optical system according to claim 1;
a digital micromirror device (DMD) which comprises a light bulb;
a set of condenser lenses for conjugating a light exit surface of a rod integrator included in the projection optical system and the light bulb; and
a projection lens for forming and projecting an enlarged image of light passed through the light bulb.

15. A projection display unit comprising:
a projection optical system according to claim 1;
a polarizing converter adjacent to a rod integrator included in the projection optical system;
a liquid-crystal display device (LCD) which comprises a light bulb;
a cross dichroic prism combining light transmitted through the light bulb; and
a projection lens for forming and projecting an enlarged image of light passed through the cross dichroic prism.
